(19) United States
(12) Patent Application Publication
(10) Pub. No.: US 2010/0285335 A1
(43) Pub. Date: Nov. 11, 2010

(54) POLYCRYSTALLINE DIAMOND (PCD) MATERIALS

(76) Inventors: Humphrey Samkelo Lungisani Sithebe, Springs (ZA); Kaveshini Naidoo, Elma Park (ZA)

Correspondence Address: FROMMER LAWRENCE & HAUG, 745 FIFTH AVENUE- 10TH FL., NEW YORK, NY, 10151, US

(21) Appl. No.: 12/523,644

(22) PCT Filed: Feb. 5, 2008
(86) PCT No.: PCT/IB08/50407

§ 371 Date: Jul. 27, 2010

(30) Foreign Application Priority Data
Feb. 5, 2007 (ZA) 200701063

(51) Int. Cl. C04B 35/56; B32B 18/00

(52) U.S. Cl. 428/698; 501/87

(57) ABSTRACT

The invention is for a polycrystalline diamond material comprising a first phase of bonded diamond particles and a second phase interspersed through the first phase. The second phase contains vanadium in the form of the metal or vanadium carbide or vanadium tungsten carbide or two or more of these forms and may be present in the polycrystalline diamond material in the range 1 to 8 percent by mass of the material.

### BACKGROUND OF THE INVENTION

This invention relates to the manufacture of polycrystalline diamond (PCD) materials having improved wear resistance, oxidation resistance and thermal stability.

Polycrystalline diamond materials are well known in the art. Conventionally, PCD is formed by combining diamond grains with a suitable binder/catalyst to produce a green body and subjecting the green body to high pressures and temperatures to enable the binder/catalyst to promote intercrystalline diamond-to-diamond bonding between the grains. The high pressures and temperatures are generally those at which diamond is thermodynamically stable. The sintered PCD has sufficient wear resistance and hardness for use in aggressive wear, cutting and drilling applications.

The binder/catalyst for use in PCD is normally a Group VIII metal, with Co being the most common. Conventionally, PCD contains 80 to 95% by volume diamond with the remainder being the binder/catalyst.

The most common method of admixing diamond, binder/catalyst and any additional additives involves ball milling. The problem with this is that most often an inhomogeneous distribution of diamond, binder/catalyst and any additives is obtained. This results in an inferior PCD material being sintered (as evidenced by the presence of flaws) with reduced properties such as wear resistance, toughness, oxidation resistance and thermal stability.

A problem that has plagued PCD is thermal degradation. There are various causes for thermal degradation and one such cause is the graphitization of the diamond in the matrix of the PCD. It is known that graphitization of the diamond is caused by the reaction of the binder/catalyst with diamond. This normally occurs at approximately 750° C. Another cause for thermal degradation is oxidation of the diamond and that of the binder/catalyst.

One of the solutions to the above problem is to remove the binder/catalyst from the surface of the sintered PCD. This involves initially sintering the PCD, and then subjecting the PCD to an acid treatment to remove the binder/catalyst. This is a multistage process. It would be beneficial to produce a thermally stable PCD in one step.

GB 2408735 discloses a PCD material comprising a first phase of bonded diamond crystals and a second phase of a reaction product between a binder/catalyst material used to facilitate diamond bonding and a material that reacts with the binder/catalyst. This reaction product is said to have a coefficient of thermal expansion that is closer to the bonded diamond than to the binder/catalyst material and hence provide a more thermally stable PCD. The binder/catalyst and the reacting material are ball milled with the diamond prior to sintering. The only working example provided in the specification is the use of Si and SiC as the material that reacts with the binder/catalyst. It is suggested that vanadium could be used but no working example giving process details is provided. Further, it is suggested that an intermetallic VCo₃, VCo and V₃Co is formed.

U.S. Pat. No. 6,454,027 discloses a PCD material comprising a plurality of granules formed from PCD, PCBN or a mixture thereof. These granules are further distributed within a continuous second matrix that is formed from a cermet material. An example of the cermet given is WC, but vanadium carbide can also be used. The purpose of forming this sintered compact is to improve properties of fracture toughness and chipping resistance, without substantially compromising wear resistance when compared to conventional PCD materials.

GB 2372276 describes the manufacture of PCD containing a first phase comprising polycrystalline diamond and a second phase selected from a group of oxide particulates, metal carbides and metallic particulates, nitrides or mixtures thereof. This PCD showed improved toughness for roller and hammer bits. The disclosure of this patent focuses on an increased toughness without sacrificing wear resistance.

U.S. Pat. No. 4,643,741 disclose a polycrystalline diamond body by mixing pre-treated diamond crystals with silicon powder, subjecting the mixture to high pressure and high temperature. The thermostable polycrystalline diamond body is characterized in having diamond crystals uniformly distributed in the body. Furthermore, the diamond crystals are covered by beta-silicon carbide.

CA 2553567 discloses a method of producing coated ultra-hard abrasive material. The abrasive particle is coated with an inner layer by elements from groups IVa, Va, VIa, IIIb and IVb of the periodic table using metal halide gas phase deposition, CVD processes, and thermodiffusion processes. Vanadium is among the metals that is claimed to be coated onto the abrasive material.

WO 2006032984 describes the coating of abrasive particles with a matrix precursor material and then treated to render them suitable for sintering. The matrix precursor material can be converted to an oxide, nitride, carbide, oxynitride, oxycarbide, or carbonitride, or an elemental form thereof. The oxide for example can then be converted to a carbide.

### SUMMARY OF THE INVENTION

According to the present invention, there is provided a polycrystalline diamond material (PCD material) comprising a first phase of bonded diamond particles and a second phase interspersed through the first phase containing vanadium in the form of the metal, the carbide, or a vanadium tungsten carbide or a mixture of two or more of these forms of vanadium. The PCD material has excellent oxidation resistance, wear resistance and thermal stability.

The vanadium tungsten carbide may be in the form of mixed carbides or as a vanadium tungsten carbide compound.

The vanadium in the form of the metal or vanadium carbide or vanadium tungsten carbide is generally present in the PCD material in an amount of 1 to 8 mass %, more preferably 2 to 6 mass % of the material.

Essential to the invention is the presence of vanadium in the form of metal, vanadium carbide or a vanadium tungsten carbide. The second phase is substantially free of any vanadium intermetallic compound such as a vanadium cobalt intermetallic compound. Any such intermetallic compound is not detectable by XRD analysis.

The second phase will preferably contain a diamond catalyst to assist in the creation of the diamond-to-diamond bonding in the first phase. Preferred diamond catalysts are cobalt, iron and nickel or an alloy containing such a metal. In this form of the invention, the second phase preferably consists essentially only of the diamond catalyst and the vanadium in one or more of its forms. Any other components in the second phase are present in trace amounts only.

It is preferred that the oxygen content of the vanadium or vanadium carbide or vanadium tungsten carbide be as low as possible. Preferably the oxygen content of the vanadium or vanadium carbide or vanadium tungsten carbide is less than 1000 ppm, preferably below 100 ppm and more preferably below 10 ppm. This can be achieved by ensuring that pure vanadium or vanadium carbide is used or present in the green state product which is sintered.

The diamond particles may be monomodal, i.e. the diamond will be of a single average particle size or multimodal, i.e. the diamond will comprise a mixture of particles of more than one average particle size.

The PCD material of the invention preferably takes the form of a layer of PCD bonded to a surface of a cemented carbide substrate, forming a composite diamond compact. The source of the binder/catalyst will typically be, at least in part, from the carbide substrate. The carbide is preferably in the form of tungsten carbide which is the source of tungsten for the second phase.

The PCD material of the invention may be made by bringing a mass of diamond particles into contact with second phase material, which may contain vanadium or vanadium carbide, forming a green state product and subjecting the green state product to conditions of elevated temperature and pressure suitable to produce PCD, preferably conditions of elevated temperature and pressure at which diamond is thermodynamically stable. It is preferred that the oxygen content of the green state product is as low as possible and preferably below the limits described above.

The second phase material may also contain a diamond catalyst.

### BRIEF DESCRIPTION OF THE DRAWINGS

FIG. 1 is a SEM analysis of an embodiment of a PCD material of the invention;

FIG. 2 illustrates graphically the results of a thermal stability test,

FIG. 3 illustrates graphically the results of a wear resistance test,

FIG. 4 illustrates graphically the results of an oxidation resistance test, and

FIG. 5 is a SEM analysis of another embodiment of a PCD material of the invention.

### DESCRIPTION OF PREFERRED EMBODIMENTS

This invention concerns the improvement in PCD materials by virtue of the incorporation of vanadium or vanadium carbide or vanadium tungsten carbide into the second phase. As a result of the incorporation of vanadium in these various forms, the PCD material manufactured will have improved wear resistance, oxidation resistance and thermal stability.

The vanadium or vanadium carbide will be introduced into the material or green state product prior to sintering. These methods of introduction of the vanadium or vanadium carbide include mechanical mixing and milling techniques well known in the art such as ball milling (wet and dry), shaker milling and attritor milling. Other techniques may also be used such as precursor methods of generating combinations of the chosen vanadium carbides into the PCD starting materials. These include the methods described in International Publication WO2006032984.

Additional known techniques including PVD, CVD, and electrodeposition may be used.

A particular method, particularly for vanadium carbide, which is considered to be very advantageous, involves the coating of the diamond particles with hydrated oxide precursor materials using for example sol-gel techniques. These precursors described in International Publication WO2006032984 may readily be converted to intimate combinations of very fine particles including nano vanadium carbide. The intimate diamond—vanadium carbide coating can include the forms of diamond coherently coated with vanadium carbide, or discrete islands of nano vanadium carbide attached to the diamond surface.

In the powder state it is preferable that the particle size of the vanadium or vanadium carbide be comparable to the particle size of the diamond grains. It is even more preferable that the vanadium or vanadium carbide be finer than diamond grains.

It may also be advantageous to introduce the vanadium or vanadium carbide additive into the diamond layer through infiltration from an external source during the HpHT synthesis cycle. This external source may be a shim or powder layer introduced between the cemented carbide substrate and the diamond layer. The vanadium additive may also be introduced by incorporating it into the cementing phase of the carbide substrate in the earlier cementing or sintering step required to produce the cemented carbide substrate. Other similar methods such as the use of annular sources around the diamond layer would be obvious to those skilled in the art. In each of these cases, it will be necessary to select the amount of infiltrant source, or to control the degree of infiltration with condition choice, in order to achieve the final desired levels of vanadium compounds in the PCD layer.

It is also preferable that the oxygen content of the vanadium or vanadium carbide or vanadium tungsten carbide be kept as low as possible, at a level below 1000 ppm, preferably below 100 ppm and most preferably below 10 ppm.

The vanadium or vanadium carbide or vanadium tungsten carbide may be present in the second phase in a novel microstructural form. The microstructural forms include: vanadium containing precipitates dispersed/precipitated along the diamond binder/catalyst interface, vanadium containing precipitates formed in a segregated manner away from the diamond binder/catalyst interface or vanadium containing precipitates coated as a whole or in part of the diamond surface between the diamond and the binder/catalyst. These microstructures or forms are observable using the well established electron microscope techniques known in the art such as TEM, SEM, HRTEM or HRSEM. The vanadium containing precipitates include carbides (both stoichiometric and nonstoichiometric) and mixed carbides such as vanadium tungsten carbide. Solid solutions of diverse carbides are also included.

The detailed elemental character of the materials of this invention may be probed using methods known in the art such as X-ray fluorescent spectroscopy (XRF) and electron diffraction spectroscopy (EDS).

Property and mechanical behaviour advantages such as improved oxidation resistance, improved wear resistance and improved thermal stability of the PCD material of the invention are observable using techniques such as Thermogravimetric Analysis (TGA) used to measure the rate of oxidation, Paarl Granite Turning Test (PGT) used as a measure of the wear resistance, X-ray Diffraction (XRD) used as a measure to detect the various phases of compounds formed, and an abrasion test to measure wear rate.

PCD materials of this invention comprise a first region of bonded diamond particles typically in the range of 60 to 98% by volume, preferably in the range of 80 to 95% by volume of the material. The vanadium or vanadium carbide or vanadium tungsten carbide is preferably present in the PCD layer in an amount in the range of 1 to 8 mass %, more preferably 2 to 6 mass % of the PCD material.

The diamond grains or particles in the first region, which will contain substantial diamond-to-diamond bonding will typically have an average particle size in the range 1 to 50 microns. The invention has particular application to high grade PCD, i.e. PCD in which the diamond particles are fine and more particularly to PCD where the diamond particles have a size of less than 20 microns.

The PCD material is preferably bonded to a substrate such as a cemented carbide substrate, generally as a layer of PCD. The source of the binder/catalyst will typically be, at least in part, the carbide substrate. The carbide is preferably in the form of tungsten carbide which is the source of the tungsten of the second phase.

The invention will now be illustrated by the following examples.

### Example 1

A mixture of 3 mass % vanadium carbide and 2 mass % cobalt powder was initially ball milled for 1 hour in order to form a uniform mixture. A bimodal distribution of diamond particles (average particle sizes of 2 microns and 12 micron) was then added stepwise to the mix and the mixture was further ball milled. In total, the overall mixture was ball milled for 4.5 hours. Scanning electron microscopy (SEM) showed the resultant mixture to be homogeneous. The mixture was then backed with a cemented tungsten carbide substrate and treated in a vacuum furnace to remove any impurities. The green state product was subjected to high pressures and temperatures at which diamond is thermodynamically stable to produce a composite diamond compact comprising a layer of PCD bonded to a cemented carbide substrate.

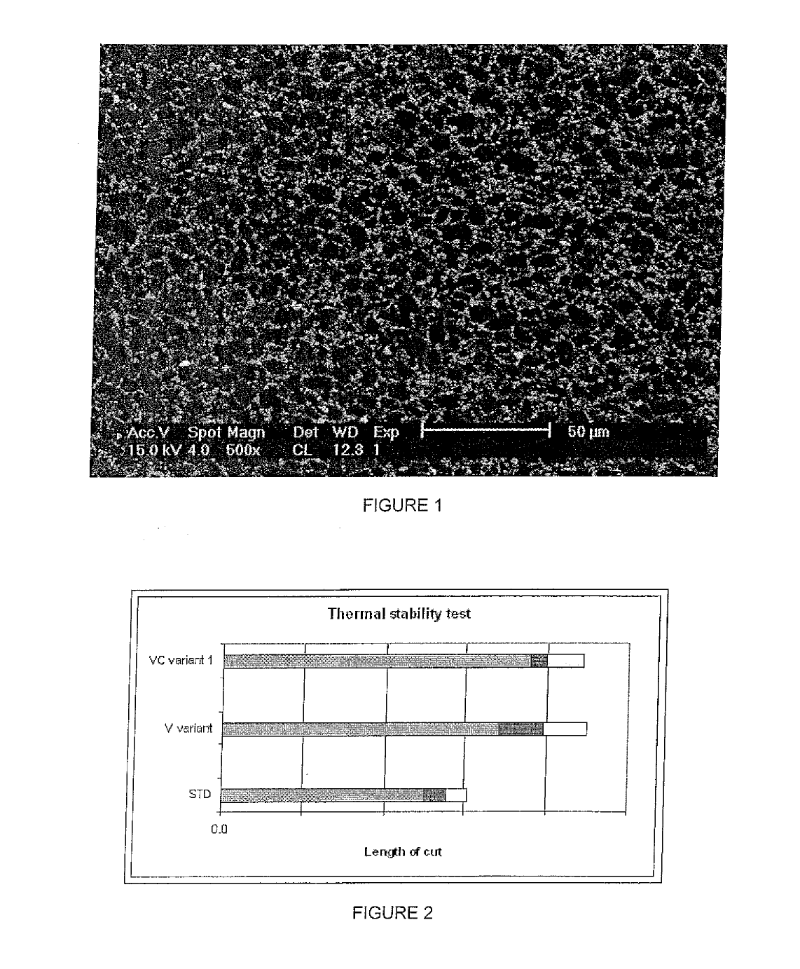

SEM analysis (FIG. 1) showed the presence of diamond intergrowth in the PCD layer. The dark regions in the micrograph represent the diamond phase, the grey regions represent the binder/catalyst cobalt and the lighter regions represent the tungsten carbide and vanadium carbide phases. The grey and lighter regions represent the second phase and are interspersed through the diamond phase. Electron diffraction spectroscopy (EDS) measures the elements present in a sample. EDS analysis further shows that the lighter regions represent the presence of vanadium and/or tungsten in the binder pools. The presence of vanadium in the sintered compact was further confirmed by XRF analysis.

XRD analysis of the PCD layer failed to reveal any vanadium-cobalt intermetallic compounds, namely VCo, V₃Co or VCo₃. The vanadium present in the PCD layer was largely observed to occur as either vanadium carbide or as vanadium tungsten carbide.

The composite diamond compact of this example was subjected to a thermal stability test and compared with a conventional composite diamond compact having a PCD layer having cobalt as the second phase. This test clearly showed an improvement in thermal stability of the composite diamond compact of the invention when compared to the standard (the conventional composite diamond compact), shown graphically in FIG. 2.

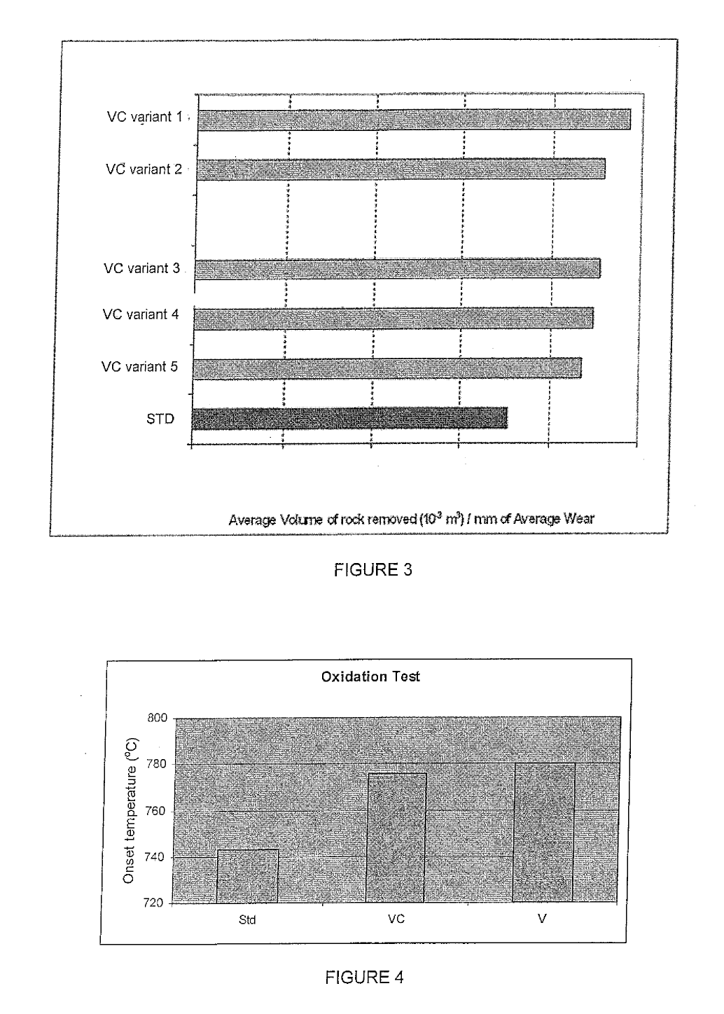

The composite diamond compact of this example was also compared with the standard in an abrasion resistance test. Five variants of the compact differing from one another in sintering conditions only were compared with the standard and all five variants showed superior abrasion resistance to the standard, as can be seen graphically in FIG. 3.

The composite diamond compact of this example was compared with the standard in an oxidation resistance test, and again proved superior as can be seen graphically in FIG. 4.

### Example 2

A mixture of 5 mass % vanadium metal and 12 micron diamond particles was ball milled for 2 hours in order to form a uniform mixture. Scanning electron microscopy (SEM) showed the resultant mixture to be homogeneous. The mixture was then backed with a cemented tungsten carbide substrate and treated in a vacuum furnace to remove any impurities. The green state product was then subjected to high pressures and temperatures at which diamond is thermodynamically stable in order to obtain a composite diamond compact comprising a layer of PCD bonded to a cemented carbide substrate.

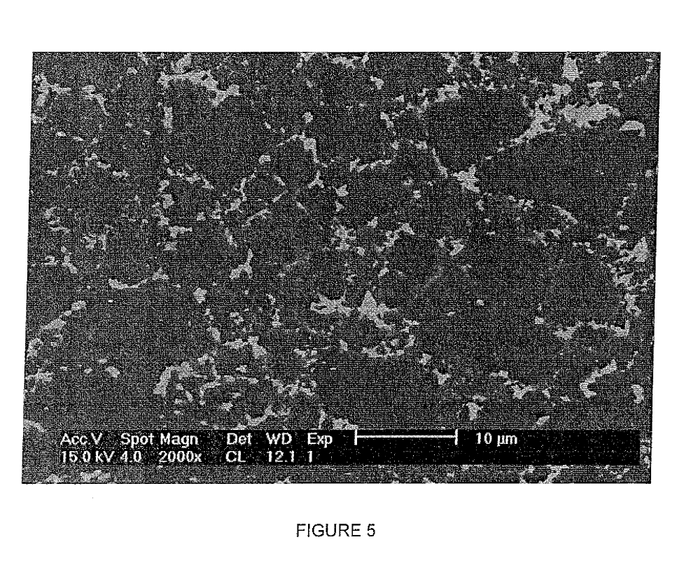

SEM analysis (FIG. 5) showed the presence of diamond intergrowth, the diamond phase, in the PCD layer. EDS analysis showed that the presence of vanadium and/or tungsten in the binder pools interspersed through the diamond phase. The presence of vanadium in the sintered compact was further confirmed by XRF analysis.

The composite diamond compact of this example was subjected to an abrasion resistance test and compared with the standard described in Example 1. The composite diamond compact of this example showed superior wear resistance compared to the standard.

The composite diamond compact of this example was also analysed using XRD and no distinct vanadium-cobalt intermetallic compounds, namely VCo, V₃Co or VCo₃, were observed. The vanadium present in the PCD layer was largely observed to occur as either vanadium carbide or as vanadium tungsten carbide or a similar phase.

The composite diamond compact of this example was shown to have greater thermal stability and oxidation resistance than the standard as can be seen graphically in FIGS. 2 and 4, respectively.

1. A polycrystalline diamond material comprising a first phase of bonded diamond particles; and a second phase interspersed through the first phase containing vanadium in the form of the metal, the carbide or a vanadium tungsten carbide or a mixture of two or more forms of vanadium.

2. The polycrystalline diamond material according to claim 1, wherein the vanadium in the form of the metal or vanadium carbide or vanadium tungsten carbide is present in the polycrystalline diamond material in the range 1 to 8 percent by mass of the material.

3. The polycrystalline diamond material according to claim 1, wherein the vanadium in the form of the metal or vanadium carbide or vanadium tungsten carbide is present in the polycrystalline diamond material in the range 2 to 6 percent by mass of the material.

4. The polycrystalline diamond material according to claim 1, wherein the second phase contains a diamond catalyst.

5. The polycrystalline diamond material according to claim 4, wherein the diamond catalyst is cobalt, iron, nickel, or an alloy containing such a metal.

6. The polycrystalline diamond material according to claim 4 wherein the second phase consists essentially of the diamond catalyst and the vanadium in one or more of its forms.

7. The polycrystalline diamond material according to claim 1, wherein the diamond particle size is less than 20 microns.

8. The polycrystalline diamond material according to claim 1, wherein the diamond particles are monomodal.

9. The polycrystalline diamond material according to claim 1, wherein the diamond particles are multimodal.

10. The polycrystalline diamond material according to claim 1, comprising a first phase of bonded diamond particles in the range of 60 to 98% by volume of the material.

11. The polycrystalline diamond material according to claim 1, comprising a first phase of bonded diamond particles in the range of 80 to 95% by volume of the material.

12. The polycrystalline diamond material according to claim 1, which is bonded to a cemented carbide substrate.

13. The polycrystalline diamond material according to claim 12 in which the substrate is a cemented tungsten carbide substrate.

14. A polycrystalline diamond material according to claim 1 substantially as herein described with reference to the examples and accompanying figures.
